(19) United States
(12) Patent Application Publication
(10) Pub. No.: US 2023/0103754 A1
(43) Pub. Date: Apr. 6, 2023

(54) LIQUID DROPLET DISCHARGING METHOD, METHOD FOR MANUFACTURING CONTAINER INCLUDING TISSUE BODY, AND LIQUID DROPLET DISCHARGING APPARATUS

(71) Applicants: Yusuke NONOYAMA, Kanagawa (JP); Takahiko MATSUMOTO, Kanagawa (JP); Hidekazu YAGINUMA, Kanagawa (JP); Reo MAEDA, Kanagawa (JP); Tatsuya SAMESHIMA, Kanagawa (JP); Natsuko IWASHITA, Tokyo (JP); Tomoyuki ARATANI, Kanagawa (JP); Tomofumi KITAZAWA, Kanagawa (JP); Shinnosuke KOSHIZUKA, Kanagawa (JP)

(72) Inventors: Yusuke NONOYAMA, Kanagawa (JP); Takahiko MATSUMOTO, Kanagawa (JP); Hidekazu YAGINUMA, Kanagawa (JP); Reo MAEDA, Kanagawa (JP); Tatsuya SAMESHIMA, Kanagawa (JP); Natsuko IWASHITA, Tokyo (JP); Tomoyuki ARATANI, Kanagawa (JP); Tomofumi KITAZAWA, Kanagawa (JP); Shinnosuke KOSHIZUKA, Kanagawa (JP)

(21) Appl. No.: 17/907,978

(22) PCT Filed: Feb. 26, 2021
(86) PCT No.: PCT/JP2021/007525

§ 371 Date: Aug. 30, 2022

(30) Foreign Application Priority Data
Mar. 9, 2020 (JP) 2020-040232
Nov. 12, 2020 (JP) 2020-188503

(51) Int. Cl. B01L 3/00

(52) U.S. Cl. CPC B01L 3/502715; B01L 3/502707; B01L 2300/0645; B01L 2300/0864; B01L 2400/02; B01L 2400/0439

(57) ABSTRACT

(Object) To improve the accuracy of the placement of liquid droplets. (Means of Achieving the object) A liquid droplet discharging method is performed by a liquid droplet discharging apparatus configured to discharge a liquid droplet from a nozzle hole formed in a film-like member, the liquid droplet discharging method including positioning the nozzle hole inside a recessed portion provided in a container; and discharging the liquid droplet from the nozzle hole positioned inside the recessed portion.

### TECHNICAL FIELD

The present application relates to a liquid droplet discharging method, a method for manufacturing a container including a tissue body, and a liquid droplet discharging apparatus.

### BACKGROUND ART

In recent years, along with advances in the stem cell technology, a technique has been developed to place a tissue body including multiple cells at a desired position. For example, in the field of drug discovery and toxicology evaluation, assays have been conducted as tests for verifying the response of cells to drugs using well plates (containers) having a plurality of wells (recessed portions) that are well-shaped holes, and a technique has been developed to place a tissue body in a well plate to reproduce the phenomena, which is occurring in the human body, in the well plate.

As a method of placing the tissue body at a desired position, there has been disclosed a configuration in which a film-like member having a nozzle hole formed therein is oscillated to discharge liquid droplets including a cell suspension or the like (see, for example, Patent Literature 1).

### CITATION LIST

### Patent Literature

PTL 1: Japanese Patent No. 6543927

### SUMMARY OF INVENTION

### Technical Problem

However, in the configuration of Patent Literature 1, there is margin for improvement in the accuracy in the placement of liquid droplets.

The disclosed technology is thus intended to improve the accuracy of the placement of liquid droplets.

### Solution to Problem

According to an aspect of the present invention, a liquid droplet discharging method is performed by a liquid droplet discharging apparatus configured to discharge a liquid droplet from a nozzle hole formed in a film-like member, the liquid droplet discharging method including positioning the nozzle hole inside a recessed portion provided in a container; and discharging the liquid droplet from the nozzle hole positioned inside the recessed portion.

### Effects of Invention

According to an embodiment of the present invention, the accuracy of the placement of liquid droplets can be improved.

### BRIEF DESCRIPTION OF DRAWINGS

FIG. 1 is a diagram illustrating an overall configuration of a liquid droplet discharging apparatus according to a first embodiment of the present invention.

FIG. 2 is a diagram illustrating a configuration example of a MEMS chip according to the first embodiment of the present invention.

FIG. 3A is a diagram illustrating an example of the coupling between a lower electrode of a piezoelectric element and a wiring according to the first embodiment of the present invention.

FIG. 3B is a diagram illustrating an example of the coupling between an upper electrode of a piezoelectric element and a wiring according to the first embodiment of the present invention.

FIG. 4 is a diagram illustrating the MEMS chip viewed from the discharge direction of a liquid droplet according to the first embodiment of the present invention.

FIG. 5 is a diagram illustrating a discharge head viewed from the discharge direction of the liquid droplet according to the first embodiment of the present invention.

FIG. 6 is a diagram illustrating the MEMS chip viewed from the discharge direction of the liquid droplet according to a modified example of the first embodiment of the present invention.

FIG. 7 is a diagram illustrating an example of a driving waveform according to the first embodiment of the present invention.

FIG. 8A is a diagram illustrating an example of a process of forming a liquid droplet according to the first embodiment of the present invention.

FIG. 8B is a diagram illustrating an example of a process of forming a liquid droplet according to the first embodiment of the present invention.

FIG. 8C is a diagram illustrating an example of a process of forming a liquid droplet according to the first embodiment of the present invention.

FIG. 9 is a diagram illustrating a first example of a driving waveform applied to a piezoelectric element according to the first embodiment of the present invention.

FIG. 10 is a diagram illustrating a second example of a driving waveform applied to a piezoelectric element according to the first embodiment of the present invention.

FIG. 11 is a diagram illustrating a third example of a driving waveform applied to a piezoelectric element according to the first embodiment of the present invention.

FIG. 12 is a diagram illustrating an overall configuration of a liquid droplet discharging apparatus according to a second embodiment of the present invention.

FIG. 13 is a diagram illustrating an example of a current generated in a piezoelectric element according to the second embodiment of the present invention.

FIG. 14 is a block diagram illustrating an example of a functional configuration of a control unit according to the second embodiment of the present invention.

FIG. 15 is a flowchart illustrating an example of an operation of a liquid droplet discharging apparatus according to the second embodiment of the present invention.

FIG. 16 is a diagram illustrating a configuration example of the MEMS chip according to a third embodiment of the present invention.

FIG. 17 is a block diagram illustrating an example of a functional configuration of a control unit according to the third embodiment of the present invention.

FIG. 18 is a flowchart illustrating an example of an operation of a liquid droplet discharging apparatus according to the third embodiment of the present invention.

### DESCRIPTION OF EMBODIMENTS

Hereinafter, an embodiment for carrying out the present invention will be described with reference to the drawings. In the drawings, the elements having the same configuration are denoted by the same reference numerals, and overlapping descriptions are omitted accordingly.

The liquid droplet discharging method according to an embodiment is performed by a liquid droplet discharging apparatus that discharges liquid droplets from a nozzle hole formed in a film-like member. In an embodiment, the nozzle hole formed in the film-like member is positioned inside a recessed portion provided in a container, and liquid droplets are discharged from the nozzle hole positioned inside the recessed portion. This improves the accuracy of the placement of liquid droplets into the inside of the recessed portion as compared to cases where liquid droplets are discharged from the outside of the recessed portion.

In the diagrams described below, in some cases, the directions are represented by an X axis, a Y axis, and a Z axis. The X direction along the X axis represents a predetermined direction in the array plane in which a plurality of the wells (recessed portions) included in the well plate (container) are arranged. The Y direction along the Y axis represents a direction perpendicular to the X direction in the array plane. The Z direction along the Z axis represents a direction perpendicular to the array plane.

The direction in which the arrow is oriented in the X direction is referred to as the +X direction, and the direction opposite to the +X direction is referred to as the -X direction. The direction in which the arrow is oriented in the Y direction is referred to as the +Y direction, and the direction opposite to the +Y direction is referred to as the -Y direction. The direction in which the arrow is oriented in the Z direction is referred to as the +Z direction, and the direction opposite to the +Z direction is referred to as the -Z direction. In an embodiment, the discharge head discharges liquid droplets in the -Z direction as an example.

### First Embodiment

### Example of Overall Configuration of a Liquid Droplet Discharging Apparatus 100

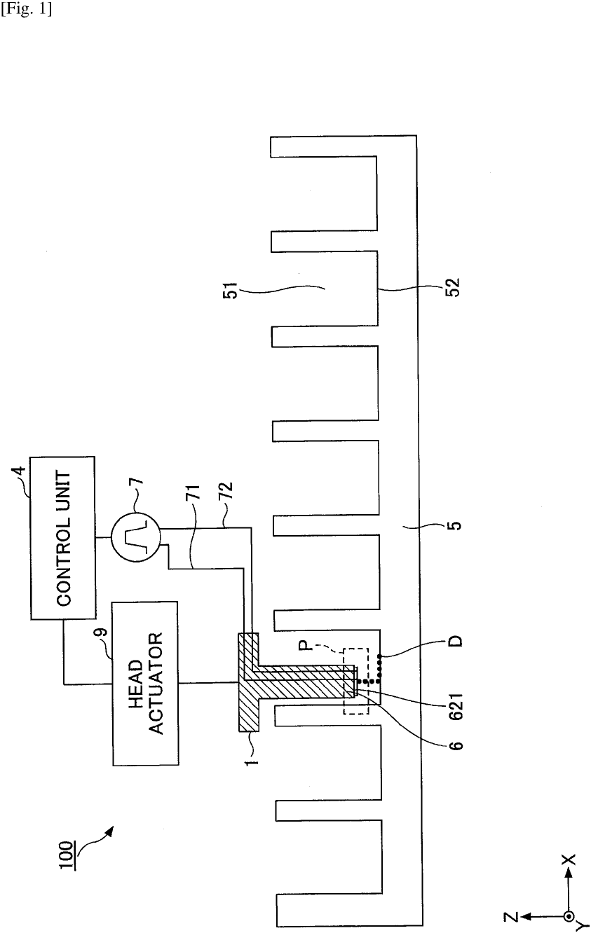

First, the overall configuration of the liquid droplet discharging apparatus 100 will be described with reference to FIG. 1. FIG. 1 is a diagram illustrating an example of the overall configuration of the liquid droplet discharging apparatus 100.

As illustrated in FIG. 1, the liquid droplet discharging apparatus 100 includes a discharge head 1, a control unit 4, and a head actuator 9.

In the liquid droplet discharging apparatus 100, one end of the discharge head 1 is inserted into a well 51 that is one of a plurality of well-shaped holes formed in a well plate 5 that is a flat plate-like member. The well plate 5 is an example of a container and an example of a container containing a tissue body. The well 51 is an example of a recessed portion.

The well plate 5 includes a plurality of the wells 51 arranged in a two-dimensional array within an array plane. Preferably, the well 51 has a substantially cylindrical shape and a bottom portion 52 of the well 51 is planar. However, the well 51 may be shaped as a substantially square column and the like instead of being cylindrical, or the well 51 may have inclined side walls, or the bottom portion 52 may be inclined.

The well plate 5 is exemplified in an embodiment, but the container may have a plate-like shape such as a plate or a slide glass or may have a tube-like shape. Further, a configuration in which the container includes a plurality of the wells 51 is exemplified; however, the number of the wells 51 may be one.

The discharge head 1 is provided with a Micro Electro Mechanical System (MEMS) chip 6 at the end inserted into the well 51. The discharge head 1 includes a nozzle hole 621 in the MEMS chip 6. The discharge head 1 is an example of a discharger that discharges the liquid held in the MEMS chip 6, as a liquid droplet D, into the well 51 from the nozzle hole 621, when a driving waveform generation source 7 applies a driving waveform (driving voltage) to the MEMS chip 6 via wirings 71 and 72.

The control unit 4 is a control device (controller) that controls the operations of the entire liquid droplet discharging apparatus 100. For example, the control unit 4 can control the application of the driving waveform to the discharge head 1 by the driving waveform generation source 7 and the operation of positioning the nozzle hole 621 by the head actuator 9.

The head actuator 9 includes a holder for holding the discharge head 1 and a moving mechanism portion for advancing and retracting in the directions of the three axes of the X axis, the Y axis, and the Z axis. The head actuator 9 is an example of a positioner for positioning the nozzle hole 621 inside the well 51 of the well plate 5 by changing the position of the discharge head 1 held by the holder. The head actuator 9 further includes a rotation mechanism unit that may be configured to vary the orientation of the nozzle hole 621.

Here, in the liquid droplet discharging apparatus 100, the nozzle hole 621 is preferably positioned at a height within a range of 0.5 mm to 3.0 mm from the bottom portion 52 of the well 51, in view of the accuracy in the placement of the liquid droplet D in the well 51. Further, the height of each of the wells 51 in the well plate 5, which includes 96 wells as an example of a suitable well plate, is approximately 12 mm, and, therefore, it is preferable to position the nozzle hole 621 at a depth of 70% or more with respect to the depth of the well 51.

For example, when the nozzle hole is positioned outside the well and a liquid droplet is discharged, the distance from the bottom of the well is long, and, therefore, the accuracy of placing the liquid droplet within the well may be reduced. Similarly, when the nozzle hole is positioned at a depth of several percent from the opening side of the well (on the opposite side to the bottom in the Z direction), and a liquid droplet is discharged, the distance from the bottom of the well is long, and, therefore, the accuracy of placing the liquid droplet may be reduced. Further, when the distance from the bottom of the well is long, a portion of the discharged liquid may be caused to scatter, and, therefore, it may not be possible to obtain the desired shape of the liquid droplet.

On the other hand, in the liquid droplet discharging apparatus 100, the liquid droplet D is discharged upon positioning the nozzle hole 621 inside the well 51. Therefore, the liquid droplet discharging apparatus 100 discharges the liquid droplet D at a short distance from the bottom portion 52 of the well 51. Accordingly, the accuracy of the placement of the liquid droplet D within the well 51 can be improved. Further, by discharging the liquid droplet D at a short distance from the bottom portion 52, it is possible to prevent a portion of the discharged liquid from being scattered.

The discharge head 1 is preferably configured so as not to interfere with the wall surface of the well 51 in order to bring the nozzle hole 621 close to the bottom portion 52 of the well 51. For this purpose, it may be considered to configure the discharge head to include a narrow tube, such as a needle or tube, and position the nozzle hole provided in the narrow tube within the well 51. However, such a configuration has many disadvantageous points in terms of discharging cell suspensions or particles, and, therefore, it is difficult to employ such a configuration.

More specifically, when a fluid, such as a cell suspension or a particle, is discharged from the nozzle hole through a narrow tube, generally, the resistance applied to the fluid is increased. This significantly reduces the discharging force, and, therefore, it will not be possible to perform the discharging in the intended manner. Moreover, particles such as cells tend to become clogged in a narrow tube, and, therefore, it is difficult to maintain the flow path through which the fluid flows in a narrow tube. Further, pressure and shear stress tend to be strongly applied to the inside of a narrow tube, which increases the risk of cell death.

### Example of Configuration of the Discharge Head 1

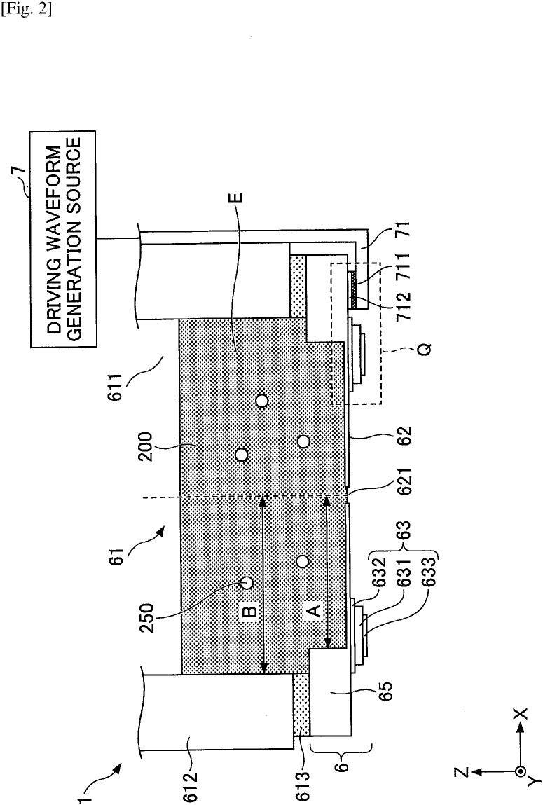

Next, the configuration of the discharge head 1 will be described also with reference to FIG. 2. FIG. 2 is an enlarged view illustrating an example of a configuration of the discharge head 1 near a portion P illustrated in FIG. 1 with dashed lines. As illustrated in FIG. 2, the discharge head 1 includes a chamber 61 and the wiring 71.

The chamber 61 is an example of a liquid chamber for holding a liquid 200, and includes an atmospheric opening part 611, a liquid chamber member 612, an elastic member 613, and the MEMS chip 6. FIG. 2 illustrates an example of the chamber 61 in a state where the liquid 200, which is a particle suspension in which sedimentable particles 250 are suspended (in which the sedimentable particles 250 are dispersed), is held. The sedimentable particles 250 may be metal particles, inorganic particles, or cells, particularly cells of human origin.

The size of the chamber 61 and the volume of the liquid 200 that can be contained in the chamber 61 are not particularly limited and may be selected as appropriate depending on the purpose. The volume of the liquid 200 may be, for example, from 1 µL to 1 mL, or 1 µL to 50 µL if the liquid 200 is a cell suspension or the like in which cells are dispersed. However, the volume of the liquid 200 varies under the control of the control unit 4 as a factor contributing to the oscillation characteristics of the membrane 62. A liquid volume E illustrated in FIG. 2 represents the volume of the liquid 200 filled in the chamber 61.

The atmospheric opening part 611 is the part where the chamber 61 opens to the atmosphere. In the chamber 61, the atmospheric opening part 611 is on the +Z direction side of the chamber 61. Air bubbles mixed into the liquid 200 can be discharged from the atmospheric opening part 611.

The MEMS chip 6 is a device fabricated by micromachining a silicon substrate by a semiconductor process using photolithography and is an example of an oscillator (oscillating unit) in which a membrane 62, a piezoelectric element 63, and a membrane support part 65 are integrated.

The MEMS chip 6 is bonded to the end portion of the liquid chamber member 612 that extends along the direction in which the liquid droplet D is discharged (the -Z direction in FIG. 2). The chamber 61 holds the liquid 200 in a space formed by bonding the liquid chamber member 612 and the MEMS chip 6 via the elastic member 613.

The external shape of the MEMS chip 6 is preferably similar to the shape of the bottom portion 52, in order to place a larger tissue body model at the bottom portion 52 of the well 51. For example, typically, the bottom portion 52 of the well 51 in the well plate 5 having 96 wells is circular, and, therefore, preferably, the MEMS chip 6 is also circular.

However, in the semiconductor process, it is generally highly difficult to process an object into a circular shape, and, therefore, a polygon, such as a quadrangle, a hexagon, or an octagon, may be formed. It is preferable to form a polygon that is as circular as possible within the machinable range. Further, the shape of the bottom portion 52 of the well 51 may be substantially a square, and, therefore, the outer shape of the MEMS chip 6 may be modified accordingly depending on the shape of the bottom portion 52.

The substrate of the MEMS chip 6 is not limited to silicon, and other materials, such as glass, may be used. Further, the method of manufacturing the piezoelectric element 63 is not limited to a semiconductor process, and may be manufactured by processes other than a semiconductor process, such as inkjet patterning of a precursor liquid of a piezoelectric body.

The membrane 62 is an example of a film-like member fixed to the -Z direction end of the chamber 61, and is formed integrally with the membrane support part 65 of the MEMS chip 6. The membrane 62 includes the nozzle hole 621 that is a through hole substantially at the center of the membrane 62. The membrane support part 65 is an example of a support member supporting the membrane 62.

The discharge head 1 discharges the liquid 200 held in the chamber 61 as the liquid droplet D from the nozzle hole 621 by the oscillation of the membrane 62. The shape of the planar portion of the membrane 62 may be circular, for example, but may be elliptical or a square. It is also preferable that the shape of the planar portion of the membrane 62 is substantially similar to the bonding surface with the liquid chamber member 612.

When a membrane size A from the nozzle hole 621 to the outer end of the membrane 62 is larger than a liquid chamber member size B from the nozzle hole 621 to the inner end of the liquid chamber member 612, air is likely to remain in the overhang portion of the liquid chamber member 612, and this may impair the discharge function. Therefore, it is preferable that the membrane size A is smaller than the liquid chamber member size B.

The nozzle hole 621 is preferably formed as a circular through hole substantially at the center of the membrane 62, but may have a polygon-shaped planar shape. In the case of a circular shape, the diameter of the nozzle hole 621 is not particularly limited, but it is preferable that the diameter of the nozzle hole 621 is at least twice the size of the sedimentable particle 250 in order to avoid clogging of the nozzle hole 621 by the sedimentable particle 250 and to stably discharge the liquid droplet D. Specifically, it is preferable that the diameter of the nozzle hole 621 is 10 µm to 100 µm or more to accommodate the cell being used, because the size of animal cells, particularly human cells, is generally approximately 5 µm to 50 µm.

On the other hand, if the size of the liquid droplet D becomes too large, it is difficult to achieve the purpose of forming the microscopic liquid droplet D. Therefore, it is preferable that the diameter of the nozzle hole 621 is 200 µm or less. Accordingly, in the liquid droplet discharging apparatus 100, the diameter of the nozzle hole 621 typically ranges from 10 µm to 200 µm.

The piezoelectric element 63 is an example of an exciter (exciting unit) which oscillates the membrane 62, and is integrally formed with the MEMS chip on the underside of the membrane 62. The shape of the piezoelectric element 63 can be designed to match the shape of the membrane 62. For example, when the planar shape of the membrane 62 is circular, it is preferable to form the piezoelectric element 63 having a planar shape that is a ring shape around the nozzle hole 621.

The piezoelectric element 63 includes a piezoelectric body 631, a lower electrode 632 provided on the upper surface side of the piezoelectric body 631 (-Z direction side surface), and an upper electrode 633 provided on the lower surface side of the piezoelectric body 631 (+Z direction side surface). The lower electrode 632 and the upper electrode 633 are examples of a plurality of electrodes, and each of the lower electrode 632 and the upper electrode 633 is an example of an electrode.

The application of a driving waveform to the lower electrode 632 or the upper electrode 633 of the piezoelectric element 63 causes the piezoelectric element 63 to contract in the X direction so that compressive stress is applied, thereby causing the membrane 62 to oscillate along the Z direction. As the material of the piezoelectric body, for example, zirconate titanate may be used. Various other materials may be used, such as bismuth iron oxide, metal niobic acid, barium titanate, or a combination of metal or different oxides added to these materials.

One end of the wiring 71 is coupled to a wiring coupling part 712 of the MEMS chip 6 via a conductive adhesive 711. The wiring 71 is also drawn out to the outer side surface of the liquid chamber member 612 and is disposed along the outer side surface so that the other end is coupled to the driving waveform generation source 7.

The piezoelectric element 63 oscillates the membrane 62 according to a voltage applied to each of the lower electrode 632 and the upper electrode 633 through the wiring 71 coupled via the conductive adhesive 711. Here, the conductive adhesive 711 is an adhesive having conductivity made of an epoxy resin material or the like mixed with a conductive filler.

As the method of coupling the wiring 71 to the MEMS chip 6, typical wire bonding or the like may be applied. However, in this case, a protrusion in the mounting portion will be formed in the discharge direction of the liquid droplet D, which may contact the liquid droplet D placed at the bottom portion 52 of the well 51. Therefore, it is preferable to achieve a minimum height of the wiring 71 and the MEMS chip 6 by pressure contact by the conductive adhesive 711. Note that the mounting technique is not limited to wire bonding, but other methods may be applied as long as the wiring is coupled stably. Although only the wiring 71 is illustrated in FIG. 2, the wiring 72 illustrated in FIG. 1 may have the same configuration and may be coupled in the same manner as the wiring 71.

In the liquid chamber member 612, the wiring 71 is fixed to the outer surface of the liquid chamber member 612 by an adhesive or a double-sided tape or the like. However, if the wiring 71 protrudes on the outer surface of the liquid chamber member 612, the discharge head may collide with the inner wall of one well when the nozzle hole 621 is positioned inside the well, which may cause constraints in the placement of the liquid droplet D including a tissue body. Therefore, it is preferable to form a groove portion for accommodating the wiring 71 on the outer surface of the liquid chamber member 612 so that the wiring 71 is accommodated inside the groove portion and the wiring 71 is fixed to the liquid chamber member 612.

It is preferable that the wiring 71 is as thin as possible and the wiring 71 is made of a material with which wiring work can be easily performed. For example, it is preferable to prepare a flat conducting wire with an insulating coating and to peel off the coating only at the end to couple the wiring 71.

The elastic member 613 is a member that includes an elastic body that does not transmit oscillations, generated by driving the MEMS chip 6, to the liquid chamber member 612 as much as possible. The elastic member 613 also functions to bond the liquid chamber member 612 to the MEMS chip 6. For example, the elastic member 613 may be formed by an adhesive that adheres the MEMS chip 6 and the liquid chamber member 612. However, the elastic member 613 may not necessarily be provided because the main function as the discharge head 1 can be achieved even if the elastic member 613 is a hard substance or the liquid chamber member 612 and the MEMS chip 6 are directly bonded without the elastic member 613.

The liquid droplet D is to be placed at the bottom portion 52 of the well 51, and, therefore, the outer shape of the portion of the liquid chamber member 612 to be inserted into the well is preferably substantially similar to the shape of the bottom portion 52 of the well 51 so that the range of movement of the discharge head 1 can be maximally secured. For example, in the case of a well plate having 96 wells, the bottom portion 52 of the well 51 is generally approximately 6 mm in diameter, and, therefore, it is preferable that the outer shape of the portion of the liquid chamber member 612 inserted into the well is circular with a diameter of approximately 3 mm to 5 mm.

The shape of the liquid chamber member 612, at the portion that is not inserted into the well 51, is formed in addition to a cylindrical shape in accordance with the shape of the holding portion of the liquid chamber.

Preferably, the material of the liquid chamber member 612 is of low cytotoxicity and is heat resistant and is highly processable. Examples of the material are polyether ether ketones (PEEKs), or polycarbonates (PCs), which are so-called engineering plastics. However, materials such as other plastics, metals, ceramics, etc., may be applied. In terms of heat resistance, the material would be easier to use if the material can endure a process of autoclave (high pressure, 120° C.) for sterilization, but this is not essential because there are other means such as ethanol and UV irradiation.

The driving waveform generation source 7 is a signal generator that outputs a driving waveform to the piezoelectric element 63 as a driving signal. The driving waveform generation source 7 can deform the membrane 62 by outputting a driving waveform to the piezoelectric element 63, and cause the liquid 200 contained in the chamber 61 to be discharged as the liquid droplet D. Alternatively, the membrane 62 can be deformed by a driving waveform set at a predetermined period, so that the membrane 62 is oscillated by resonance to discharge the liquid 200.

It is preferable that the MEMS chip 6 is disposed at a downstream side (-Z direction side) in the discharge direction with respect to the liquid chamber member 612. In addition to the placement of cell suspensions, the process of tissue body placement may also involve the addition of fluids and gels constituting a living body, or biocompatible fluids and gels, before and after cell placement. This contributes to factors such as cell adhesion to the well bottom, cell viability, and cell maturation.

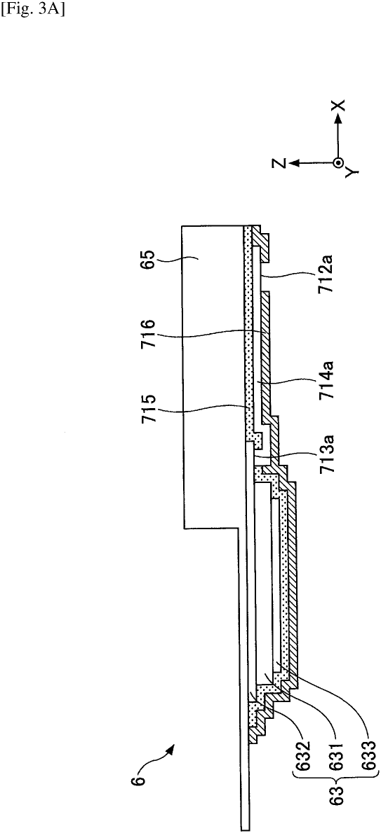

Next, FIG. 3A is a cross-sectional view illustrating an example of the coupling between the lower electrode 632 of the piezoelectric element 63 and the wiring 71 in the MEMS chip 6. FIG. 3B is a cross-sectional view illustrating an example of a coupling between the upper electrode 633 of the piezoelectric element 63 and the wiring 72 in the MEMS chip 6. FIGS. 3A and 3B each illustrate cross-sectional structures perpendicular to the Y direction of a region Q illustrated with dashed lines in FIG. 2.

As illustrated in FIG. 3A, the MEMS chip 6 includes a lower electrode wiring 714a across an interlayer insulating film 715 on the -Z direction side of the membrane support part 65. The lower electrode wiring 714a is coupled to the lower electrode 632 via a lower electrode coupling part 713a. Further, the MEMS chip 6 includes an insulating film 716 on the -Z direction side of the lower electrode wiring 714a. The portion where the insulating film 716 is removed corresponds to a lower wiring coupling part 712a coupling the wiring 71 to the lower electrode 632.

As illustrated in FIG. 3B, the MEMS chip 6 includes an upper electrode wiring 714b across the interlayer insulating film 715 on the -Z direction side of the membrane support part 65. The upper electrode wiring 714b is coupled to the upper electrode 633 via an upper electrode coupling part 713b. Further, the MEMS chip 6 includes the insulating film 716 on the -Z direction side of the upper electrode wiring 714b. The portion where the insulating film 716 is removed corresponds to an upper wiring coupling part 712b coupling the wiring 72 and the upper electrode 633.

However, these couplings are exemplary and the lower wiring coupling part 712a and the upper wiring coupling part 712b may be provided on any of the surfaces configuring the MEMS chip 6 by other methods.

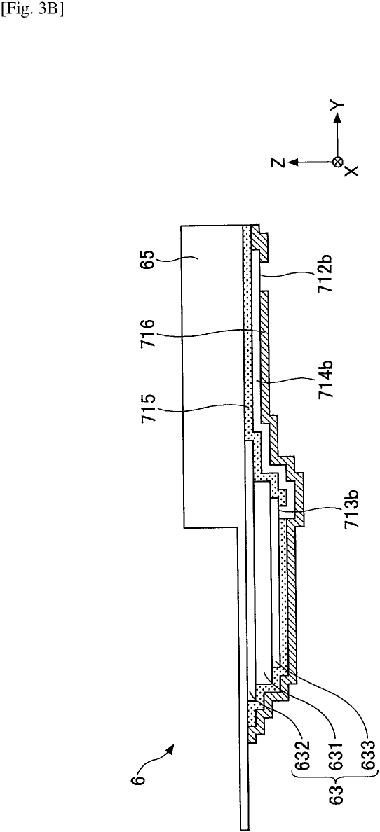

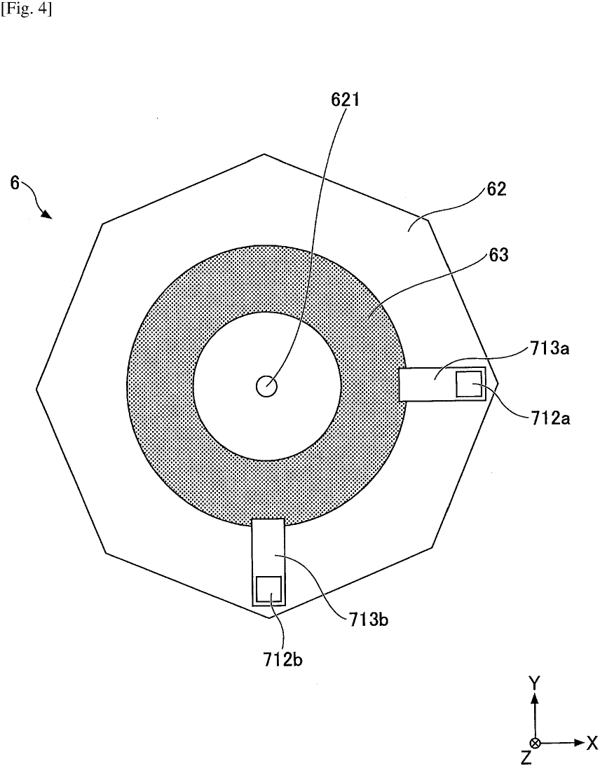

Next, FIG. 4 is a diagram illustrating the MEMS chip 6 viewed from the discharge direction of the liquid droplet. FIG. 5 is a diagram illustrating the discharge head 1 from the discharge direction of the liquid droplet. As illustrated in FIGS. 4 and 5, the outer shape the membrane 62 is an octagonal shape and the outer shape of the liquid chamber member 612 is a circular shape.

Referring to FIG. 4, the wiring 71 is coupled to the lower electrode via the lower electrode coupling part 713a and the lower wiring coupling part 712a. Further, the wiring 72 is coupled to the upper electrode via the upper electrode coupling part 713b and the upper wiring coupling part 712b.

As illustrated in FIG. 5, the liquid chamber member 612 includes a lower electrode groove part 612a and an upper electrode groove part 612b on an outer surface 610 of the liquid chamber member 612. The lower electrode groove part 612a is an example of a housing part for accommodating the wiring 71 coupled to the lower electrode, and the upper electrode groove part 612b is an example of a housing part for accommodating the wiring 72 coupled to the upper electrode.

The lower electrode groove part 612a is a groove having a U-shaped cross-sectional shape formed on the outer surface of the liquid chamber member 612 with a width and a depth that accommodate and fix the wiring 71 so that the wiring 71 does not protrude from the outer surface of the liquid chamber member 612. Similarly, the upper electrode groove part 612b is a groove having a U-shaped cross-sectional shape formed on the outer surface of the liquid chamber member 612 with a width and a depth that accommodate and fix the wiring 72 so that the wiring 72 does not protrude from the outer surface of the liquid chamber member 612. However, the housing part is not limited to a U-shaped groove as long as the wiring 71 or the wiring 72 can be accommodated inside, and may be of any cross-sectional shape, or may have a partially different width or depth.

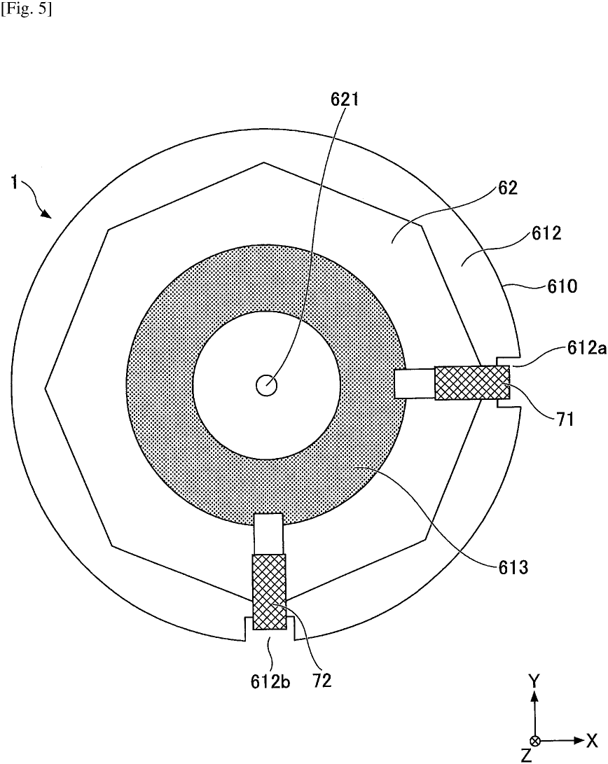

Further, FIG. 6 is a diagram illustrating a MEMS chip 6A according to a modified example of the MEMS chip 6 viewed from the discharge direction of the liquid droplet. As illustrated in FIG. 6, the MEMS chip 6A includes two piezoelectric elements 63a and 63b. For example, either one of the piezoelectric element 63a or the piezoelectric element 63b functions as an exciter for oscillating the membrane 62, while the other one functions as a detector for detecting the back electromotive force generated by the exciter.

Among the piezoelectric elements 63a and 63b, one of the piezoelectric elements that functions as the exciter is an example of a first piezoelectric element, and the other one that functions as the detector is an example of a second piezoelectric element. The discharge head 1 may be configured by using the MEMS chip 6A.

### Example of Liquid Droplet Discharging Process by the Liquid Droplet Discharging Apparatus 100

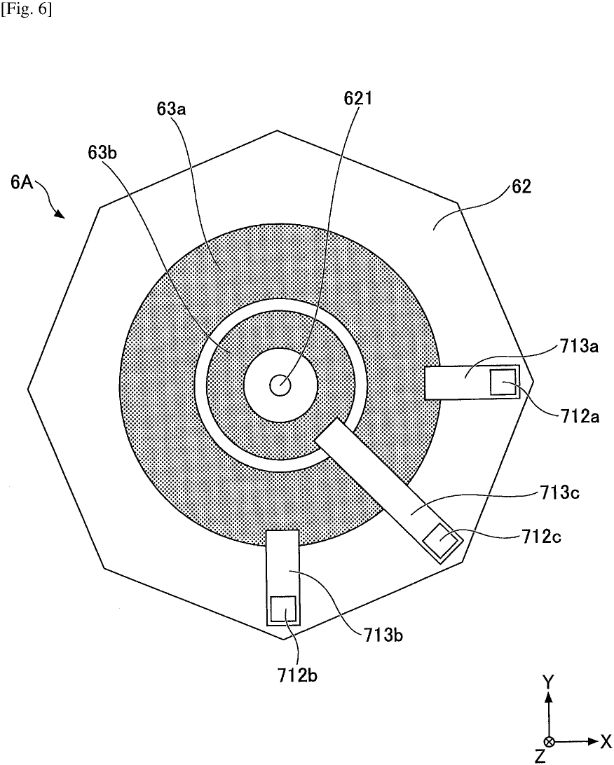

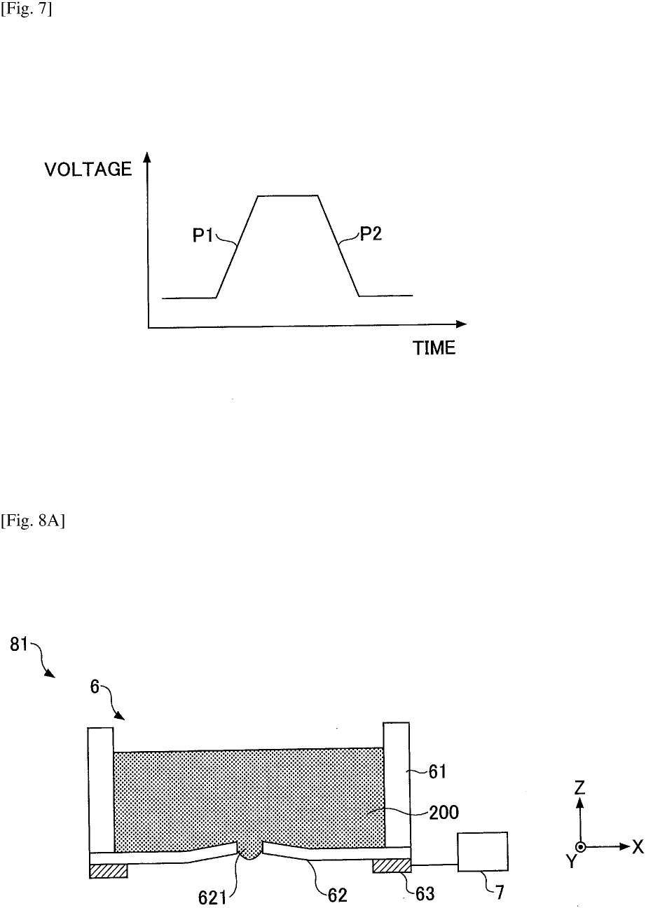

Next, the liquid droplet discharging process by the liquid droplet discharging apparatus 100 will be described with reference to FIG. 7 to 8C, which illustrate simplified configurations. FIG. 7 is a diagram illustrating an example of a driving waveform. FIGS. 8A to 8C are diagrams illustrating an example of a process of forming a liquid droplet, and illustrate a part of the liquid droplet discharging apparatus 100 (see FIG. 1).

When a waveform element P1 and a waveform element P2 illustrated in FIG. 7 are output to the piezoelectric element 63, the state of the liquid in the chamber 61 changes and the liquid droplet D is formed, as illustrated in states 81 to 83 in FIGS. 8A to 8C. A waveform element means the waveform of the period during which the voltage change is sloped, in the driving waveform.

Specifically, when the waveform element P1 is output, the piezoelectric element 63 contracts in the X direction in FIG. 8A, so that the membrane 62 near the nozzle hole 621 is suddenly deformed so as to be recessed in the +Z direction as illustrated in the state 81. In response to this deformation, the liquid 200 contained in the chamber 61 is pushed out from the nozzle hole 621 in the -Z direction.

Subsequently, as illustrated in the state 82, a liquid column protruding from the nozzle hole 621 in the -Z direction grows, and as illustrated in the state 83, the liquid droplet D is formed and the liquid droplet D is discharged along the -Z direction. The liquid droplet D is formed at a predetermined timing regardless of the timing of reducing the residual oscillation by the waveform element P2.

### Example of Various Driving Waveforms

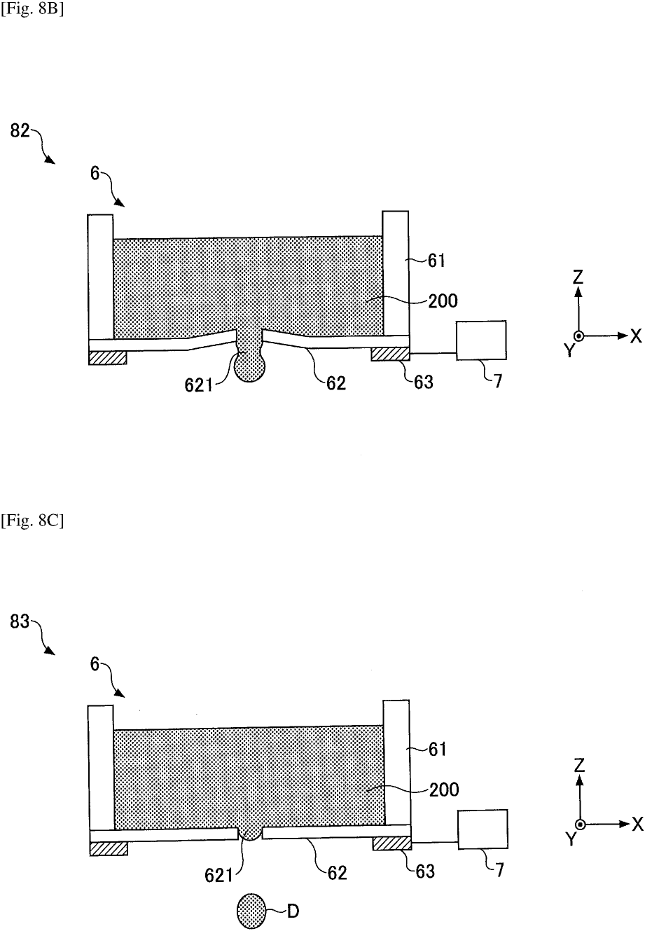

Next, various driving waveforms will be described with reference to FIGS. 9 to 11. Reference is also made to FIGS. 1 and 2, as appropriate.

FIG. 9 is a diagram illustrating a first example of a driving waveform applied to the piezoelectric element. In FIG. 9, when a waveform element P1 is applied to the piezoelectric element 63, the membrane 62 is deformed upward (in the +Z direction of FIGS. 8A to 8C). Then, a waveform element P2 is applied to the piezoelectric element 63 at the timing of a time difference T₁₂ in the driving waveform.

Here, the term “time difference in the driving waveform” according to an embodiment refers to the time difference from the start timing of the application of a predetermined waveform element to the end timing of a period in which a constant voltage value is maintained after the end of the application of the predetermined waveform element. Therefore, the time difference T₁₂ is the time difference from the start timing of the application of the waveform element P1 to the end timing of the period in which a constant voltage value is maintained after the end of the application of the waveform element P1. The time difference T₁₂ is a characteristic value determined by the design of the driving waveform and is an example of a “predetermined time difference”.

When the waveform element P2 is applied to the piezoelectric element 63, assuming that T₀ is the resonance period of the membrane 62, after the resonance period T₀ from when the membrane 62 starts oscillating by the waveform element P1, the waveform element P2 is applied to the piezoelectric element 63. The pressure caused by deformation of the membrane 62 by the waveform element P2 acts in a direction that reduces the oscillation of the membrane 62 caused by the waveform element P1.

That is, when the condition of the following formula (1) is satisfied, the waveform element P2 acts in a direction that reduces the residual oscillation of the membrane 62. T₁₂ = m×T0 (m: positive integer) ... (1)

In this case, if the time required for the waveform element P1 and the time required for the waveform element P2 are equal to each other, a balance between the discharging and the reduction of the residual oscillation can be easily achieved. Further, the more the resonance period T₀ of the membrane 62 and the time difference T₁₂ in the driving waveform deviate from the condition of formula (1), the more it becomes difficult to perform stable discharging, and, therefore, it is preferable to adjust the resonance period T₀ or the time difference T₁₂ in the driving waveform so as to satisfy the condition of formula (1).

In the present embodiment, by controlling a liquid volume E of the liquid 200 in the well 51 by the control unit 4, the resonance period T₀ is adjusted to match the time difference T₁₂ in the driving waveform. However, the present embodiment is not limited thereto, and the resonance period T₀ may be adjusted to match the time difference T₁₂ in the period of the driving waveform by other methods including a method of controlling the height of an adjustment member disposed above the nozzle hole 621 (on the +Z direction side in FIGS. 8A to 8C).

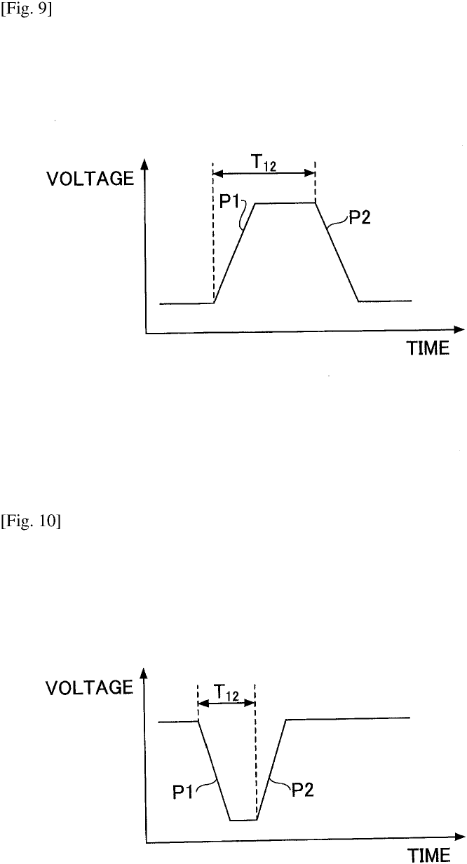

Next, FIG. 10 is a diagram illustrating a second example of a driving waveform.

As illustrated in FIG. 10, a predetermined voltage is applied to the piezoelectric element 63 in advance such that the membrane 62 is deformed to the upper side, and from this state, by applying the waveform element P1, the membrane 62 is returned to the lower side, so that the liquid level (meniscus) in the nozzle hole 621 is shifted to the upper side once, and then free oscillation occurs.

Subsequently, after maintaining a constant voltage, at the timing of the time difference T₁₂, the waveform element P2 is applied. In this case, the waveform element P2 is applied after a period of ½ of the resonance period T₀ after the membrane 62 starts oscillation by the waveform element P1, and, therefore, the membrane 62 shifts upward in synchronization with the oscillation caused by the waveform element P1. Accordingly, the force of shifting the membrane 62 upward due to the free oscillation and the force of shifting the membrane 62 upward due to the waveform element P2 are combined with each other, thereby increasing the momentum of discharging the liquid droplet.

Considering that the waveform element P1 has a certain period, when the condition of the following formula (2) is satisfied, the waveform element P2 acts in a direction that increases the momentum of the discharging. T₁₂= (m-½)×T0 (m: positive integer) ... (2)

Accordingly, the liquid droplet can be discharged, even when the voltage is low.

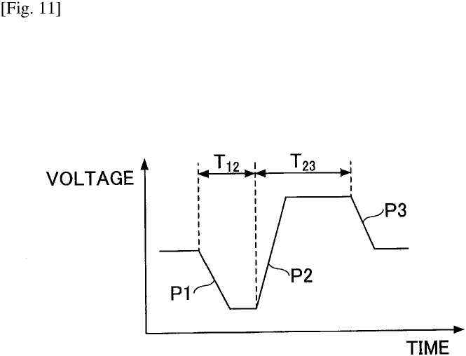

Next, FIG. 11 is a diagram illustrating a third example of a driving waveform.

As illustrated in FIG. 11, a predetermined voltage is applied to the piezoelectric element 63 in advance such that the membrane 62 is deformed to the upper side, and from this state, by applying the waveform element P1, the membrane 62 is returned to the lower side, so that the liquid level in the nozzle hole 621 is shifted to the upper side once, and then free oscillation occurs.

Subsequently, after maintaining a constant voltage, at the timing of the time difference T₁₂, the waveform element P2 is applied. Then, after maintaining a constant voltage again, at the timing of a time difference T₂₃, a waveform element P3 is applied. The time difference T₂₃ is the time difference from the start timing of the application of the waveform element P2 to the end timing of the period in which a constant voltage value is maintained after the end of the application of the waveform element P2.

In this case, when the conditions the following formulas (3) and (4) are satisfied, the waveform elements P2 and P3 act in a direction that reduces the residual oscillation of the membrane 62. T₁₂ = (m-½)×T0 (m: positive integer) ... (3) T₂₃ = n×T0 (n: positive integer) ... (4)

As described above, matching the resonance period T₀ of the membrane 62 with the time difference in the driving waveform such as the time difference T₁₂ or the time difference T₂₃, is important for stable discharge, high efficiency discharge with low voltage, and the like.

### Functional Effects of the Liquid Droplet Discharging Apparatus 100

Next, the functional effects of the liquid droplet discharging apparatus 100 will be described.

In recent years, along with advances in the stem cell technology, a technique has been developed to place a tissue body including multiple cells at any position. Particularly, in the field of drug discovery and toxicology evaluation, generally, tests (assays) have been conducted for verifying the response of cells to drugs using plates having a plurality of well-shaped holes (wells) referred to as well plates, and there is increased demand to form a tissue body in a well plate to reproduce the phenomena occurring in the human body, in the well plate.

The construction of such assays not only reduces the time and cost of screening for candidate drugs, but also has the advantages of eliminating inefficient development caused by the difference in drug responses between animals and humans, and reducing animal experiments.

Although there are a variety of types of well plates, the size of the outer shape is approximately the same. In well-known configurations of well plates, the number of wells is 6 (6 wells), 12 (12 wells), 24 (24 wells), 48 (48 wells), 96 (96 wells), and 384 (384 wells), where each well becomes smaller as the number of wells increases. For an assay system, it is preferable that the number of wells per well plate is large, and a well plate including 96 or more wells is often used. Further, a well plate with 96 wells is preferable, because if each well is too small, it is difficult to form a tissue body in the well.

Further, there is disclosed a configuration in which information used for controlling the resonant frequency of a film-like member is acquired in order to stably discharge a small amount of liquid with an apparatus that oscillates a film-like member in which a nozzle hole is formed, to discharge a liquid droplet. Examples of the means for forming a tissue body in a well plate include an extrusion method, an optical shaping method, and an inkjet method (a liquid droplet discharging method).

The extrusion method includes extruding and discharging, from a dispenser, a gel in which cells are dispersed, but the placement resolution (the resolution in placing the gel in the well) depends on the size of the dispenser needle. Thus, this method is not suitable for the formation of a tissue body requiring accurate placement, and the placement resolution is limited to a few hundred micrometers.

The optical shaping method is a method in which a gel precursor, in which cells are dispersed, is prepared in a well, and then the gel precursor is cured and shaped using an optical probe. However, when handling multiple types of cells, it is essential to wash the well in which the cells are placed first, and damage to the cells cannot be avoided.

On the other hand, with the inkjet method, non-contact discharging is performed with a high resolution of a few tens of micrometers, and, therefore, this is the most suitable method for configuring a tissue body in a well.

As a method of discharging cells by an inkjet method, there is disclosed a configuration in which a cell suspension or the like is discharged with an apparatus that oscillates a film-like member in which a nozzle hole is formed, to discharge a liquid droplet (see, for example, Patent Document 1).

Further, there is disclosed a configuration in which a liquid droplet dispensing apparatus for dispensing accurate amounts of liquid is implemented by applying the MEMS technology to an inkjet method for discharging cells (see, for example, Japanese Patent No. 4788408). Further, a technique has been disclosed for roughly placing cells in a well plate in by an inkjet method (see, for example, http://inventia.life/).

However, in the conventional technology, liquid droplets containing a tissue body is discharged from the outside of the well of the well plate, and, therefore, the flight distance from the nozzle hole to the point of landing is long. Thus, the liquid droplet cannot be placed with the desired accuracy, and the accuracy in placing the tissue body may be reduced. Further, when the speed of the liquid droplet is increased, the liquid may scatter after landing, or unintentional micro-liquid droplets referred to as satellite liquid droplets may be generated, thereby hampering the intended placement of liquid droplets, resulting in reduced accuracy in the placement of liquid droplets and reduced accuracy in the placement of the tissue body.

In the present embodiment, a nozzle hole formed in a film-like member (the membrane 62) is positioned inside a recessed portion provided in a container (the well plate 5) (positioning step), and a liquid droplet is discharged from the nozzle hole positioned inside the recessed portion (discharging step). For example, the nozzle hole is positioned at a depth of 70% or more relative to the depth of the recessed portion to discharge a liquid droplet from the nozzle hole.

The liquid droplet can be discharged from a short distance to the bottom of the recessed portion, and the tissue body contained in the liquid droplet can be placed at the bottom of the recessed portion, and, therefore, the accuracy in the placement of the liquid droplet inside the recessed portion can be improved and the accuracy of placement of the tissue body contained in the liquid droplet can be improved, as compared to cases where liquid droplets are discharged from the outside of the recessed portion.

In the present embodiment, a film-like member (the membrane 62) in which a nozzle hole is formed, is also positioned inside a recessed portion (the well 51). Therefore, a portion that causes resistance to fluid decreases, so that the liquid droplet can be discharged without impairing the discharging force. Further, in the case of discharging living cells, if the shape of the tip of the capillary tube or the like is narrow, the risk of death of living cells is increased due to the pressure. However, by the configuration of the present embodiment, it is possible to reduce such risk of death.

In the present embodiment, in the positioning process by a positioner (the head actuator 9), an oscillator (the MEMS chip 6) including a film-like member (the membrane 62), a support member (the membrane support part 65) supporting the film-like member, and an exciter (the piezoelectric element 63) for oscillating the film-like member, is positioned inside a recessed portion (the well 51).

Accordingly, the oscillator enters the inside of the well, so that an agitation operation can be performed until immediately before discharging a liquid droplet from the nozzle hole, thereby preventing particles such as cells from clogging the nozzle hole.

Further, in the present embodiment, the liquid droplets include a material constituting a living body or a biocompatible material. Accordingly, it is possible to accurately place a material constituting a living body or a biocompatible material in the recessed portion.

Further, in the present embodiment, the liquid droplet is a cell suspension including cells. Accordingly, it is possible to accurately place cells in the recessed portion.

Further, in the present embodiment, when the outer shape of the planar portion of the recessed portion and the outer shape of the planar portion of the film-like member are both circular, the diameter of the film-like member is smaller than the diameter of the planar portion of the recessed portion. Accordingly, it is possible to bring the film-like member closer to the bottom of the recessed portion having the planar portion, and to discharge the liquid droplets from the nozzle hole formed in the film-like member.

Further, in the present embodiment, the discharge head includes an oscillator in which a film-like member including a nozzle hole, a support member supporting the film-like member, and an exciter disposed on a part of the film-like member and a part of the support member are integrated; and a liquid chamber member bonded to the oscillator to hold the liquid.

For example, the oscillator is a component integrally molded by a semiconductor process and bonded to an end of a liquid chamber member that extends along the direction in which liquid droplets are discharged. With this configuration, the end of the discharge head can be miniaturized, and the liquid droplets can be discharged in a state where the nozzle hole provided at the end of the discharge head is inserted inside the recessed portion.

Further, in the present embodiment, the oscillator is bonded to the liquid chamber member via an elastic member. Accordingly, it is possible to discharge the liquid droplets while minimizing the transmission of the oscillation generated by the driving of the oscillator to the liquid chamber member and the discharge head, and, therefore, it is possible to reduce errors in the placement of the liquid droplets which would be caused by the oscillation of the discharge head.

Further, in the present embodiment, when the outer shape of the planar portion of the film-like member is circular and the liquid chamber member is a cylindrical member, the inner diameter of the end portion of the liquid chamber member on the side where the elastic member is disposed (twice the membrane size A in FIG. 2) is smaller than the diameter of the planar portion of the film-like member (twice the liquid chamber member size B in FIG. 2). Accordingly, it is possible to reduce residual air being included in the overhang portion of the liquid chamber member so that stable discharging can be performed.

Further, in the present embodiment, the exciter oscillates the film-like member according to a voltage applied through a wiring coupled to the plurality of electrodes via a conductive adhesive. This arrangement facilitates the electrical coupling between the exciter and the wiring.

Further, in the present embodiment, the wiring is accommodated within a housing part (a groove part) formed on the outer surface of the liquid chamber member. This configuration prevents the wiring from protruding on the outer surface of the liquid chamber member so that the discharge head is prevented from colliding with the inner wall of the well when the nozzle hole 621 is positioned inside the well. Accordingly, liquid droplets containing tissue body can be accurately placed.

Further, a modified example of the present embodiment includes a first piezoelectric element for oscillating the film-like member and a second piezoelectric element for detecting a back electromotive force. By this configuration, the first piezoelectric element and the second piezoelectric element can be provided in a simpler configuration.

The liquid droplet discharging method according to the present embodiment may also be referred to as a method of manufacturing a container containing a tissue body because the tissue body contained in the liquid droplet is placed in the container.

### Second Embodiment

The present embodiment includes detecting at least one of a current and a voltage, which is generated by an exciter that oscillates a film-like member that discharges liquid droplets from a nozzle hole, and controlling a factor that contributes to the oscillation characteristic of the film-like member based on the detection result. For example, the back electromotive force, which is generated by the piezoelectric element that is the exciter, is detected, and the liquid volume contributing to the resonance period of the film-like member is controlled based on the back electromotive force. Accordingly, the oscillation of the film-like member can be accurately controlled.

### Example of Overall Configuration of a Liquid Droplet Discharging Apparatus 100a

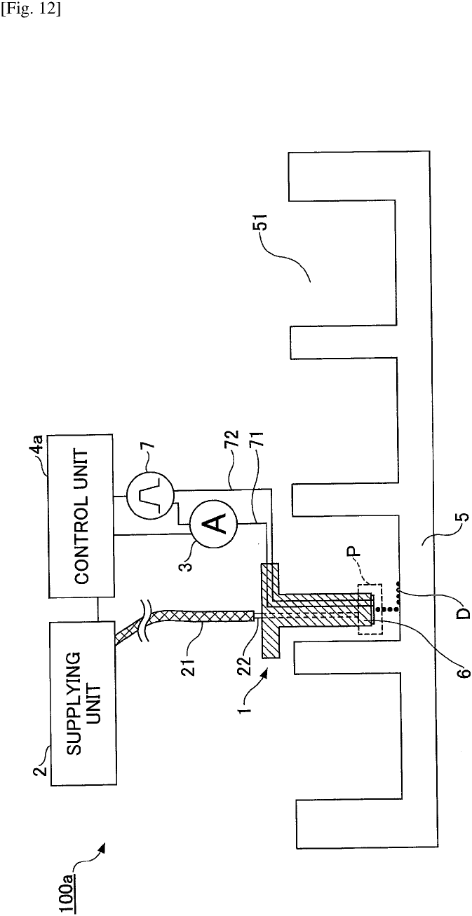

First, the overall configuration of the liquid droplet discharging apparatus 100a will be described with reference to FIG. 12. FIG. 12 is a diagram illustrating an example of the overall configuration of the liquid droplet discharging apparatus 100a.

As illustrated in FIG. 12, the liquid droplet discharging apparatus 100a includes a supplying unit 2, an ammeter 3, and a control unit 4a.

One end of the discharge head 1 is inserted into the well 51 that is one of a plurality of well-shaped holes formed in the well plate 5 that is a flat plate-like member.

The supplying unit 2 (supplier) includes a liquid feed pump and a suction pump, and feeds liquid to the chamber holding the liquid in the discharge head 1 and also sucks (absorbs) the liquid from the chamber, via a tube 21 and a supply needle 22. The volume (amount) of liquid in the chamber can be changed by the feeding or sucking of the liquid by the supplying unit 2.

The discharge head 1 discharges the liquid in the chamber to supply the liquid into the well 51. By the supplied liquid, a tissue body or the like can be formed within the well 51.

The MEMS chip 6 is provided at the end of the discharge head 1 on the side inserted into the well 51. When the driving waveform generation source 7 applies a driving waveform (driving voltage) to the MEMS chip 6 via the wirings 71 and 72, the liquid held in the MEMS chip 6 is discharged into the well 51 as the liquid droplet D.

The ammeter 3 that is an example of a detector detects the current, which is generated by the piezoelectric element included in the MEMS chip 6 in response to the liquid being discharged by the MEMS chip 6.

The control unit 4a is a control device that controls the operations of the entire liquid droplet discharging apparatus 100. The control unit 4a is provided with a function to cause the supplying unit 2 to feed or suck liquid in response to the back electromotive force of the piezoelectric element based on the current detected by the ammeter 3, and to control the volume of liquid held in the chamber of the MEMS chip 6 (see the liquid volume E illustrated in FIG. 2).

When residual oscillation occurs in the membrane 62 by the driving operation, the piezoelectric body 631 deforms due to the residual oscillation, causing a back electromotive force to be generated between the lower electrode 632 and the upper electrode 633. Here, the residual oscillation of the membrane 62 refers to oscillation remaining in the membrane 62 when the state of the membrane 62 transitions from a driven state to a stopped state.

The piezoelectric element used for detecting the back electromotive force may be the piezoelectric element that is driven for discharging liquid, but a separate piezoelectric element may be provided for the purpose of detection as described with reference to FIG. 6. With respect to the piezoelectric element 63a and the piezoelectric element 63b illustrated in FIG. 6, either one of the upper electrode or the lower electrode is electrically independent, and these piezoelectric elements can be used separately, that is, as a piezoelectric element that is to be driven and a piezoelectric element for detecting the current/voltage. Either one of the piezoelectric element 63a or the piezoelectric element 63b may be used for being driven and either one may be used for detection. This arrangement eliminates the need to switch between a drive circuit and a signal detecting circuit and allows a simpler apparatus to be constructed.

### Example of Current Generated by the Piezoelectric Element 63

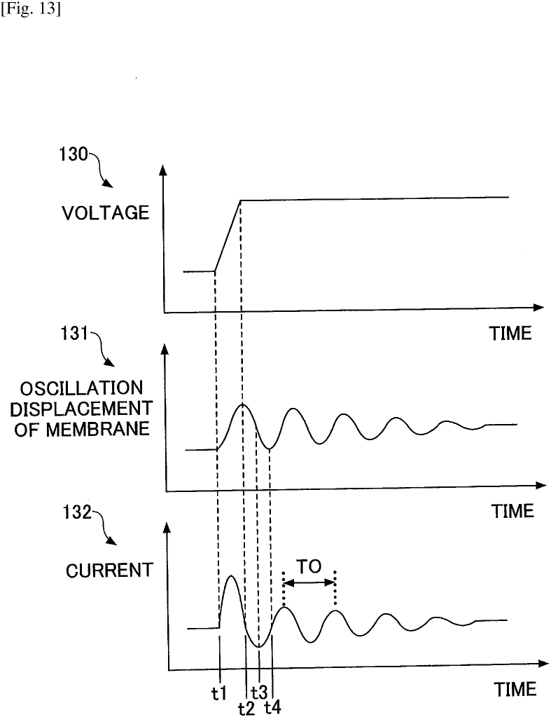

Here, the current generated by the piezoelectric element 63 will be described with reference also to FIG. 13. FIG. 13 is a diagram illustrating an example of a current generated by the piezoelectric element 63. In FIG. 13, a driving waveform 130 is a graph illustrating an example of the driving waveform, an oscillation displacement 131 is a graph illustrating an example of the oscillation displacement of the membrane 62, and a current waveform 132 is a graph illustrating an example of the current waveform detected by the ammeter 3.

In FIG. 13, as illustrated by the driving waveform 130, when the voltage of the driving waveform rises from time t1 and the driving of the piezoelectric element 63 starts, the oscillation displacement of the membrane 62 rises as illustrated by the oscillation displacement 131. Subsequently, at the timing when the voltage rise of the driving waveform stops at time t2, the oscillation displacement of the membrane 62 becomes maximum. As illustrated by the current waveform 132, the current continues to flow during the period from time t1 to time t2 when the voltage is rising, and the current stops flowing when time t2 is reached.

Subsequently, the driving of the piezoelectric element 63 is stopped, but the membrane 62 is displaced by residual oscillation. At time t3, at the timing when the velocity of the oscillation displacement becomes maximum, the current reaches an extreme value. Subsequently, at time t4, when the velocity of the oscillation displacement of the membrane 62 becomes zero, the current value returns to zero.

Thus, the current is generated in synchronization with the oscillation displacement of the membrane 62 by the residual oscillation. In the present embodiment, this current is detected by the ammeter 3 and the voltage value corresponding to the current value is detected as the back electromotive force. Further, the resonance period T₀ of the membrane 62 is detected from the time intervals between the extreme values in the temporal variation of the back electromotive force. However, the time intervals between the extreme values of the current may be detected as the resonance period T₀.

The resonance period T₀ also varies depending on the liquid volume E of the liquid 200 held in the chamber 61. Therefore, in the present embodiment, depending on the detection result of the resonance period T₀ of the membrane 62, the liquid volume E of the liquid 200 held by the chamber 61 is controlled by the control unit 4 to change the resonance period T₀ to match a predetermined time difference (described below) in the driving waveform. The resonance period T₀ is an example of the oscillation characteristic and is an example of the oscillation period.

### Example of Functional Configuration of the Control Unit 4a

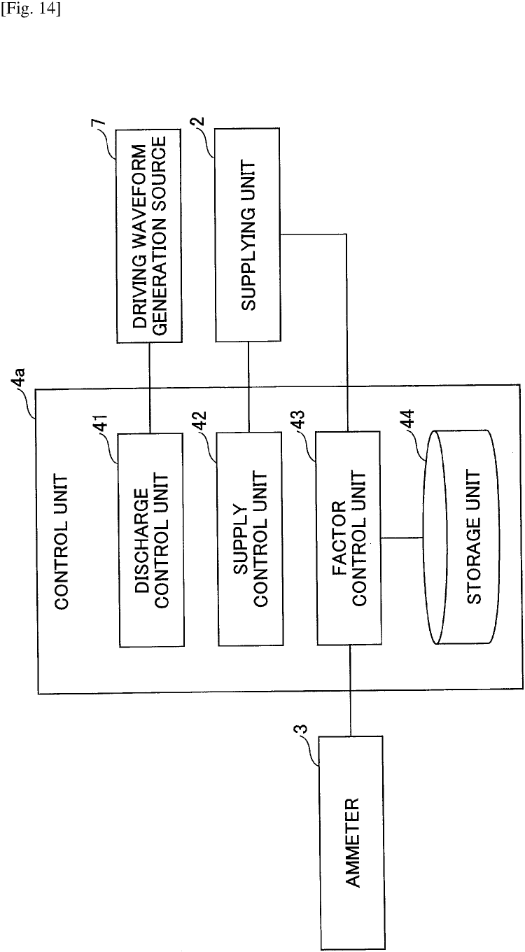

Here, the functional configuration of the control unit 4a of the liquid droplet discharging apparatus 100a will be described with reference to FIG. 14. FIG. 14 is a block diagram illustrating an example of a functional configuration of the control unit 4a.

As illustrated in FIG. 14, the control unit 4a includes a discharge control unit 41, a supply control unit 42, a factor control unit 43, and a storage unit 44. Among these, the functions of the discharge control unit 41, the supply control unit 42, and the factor control unit 43 are implemented by an electric circuit, and a portion of these functions may be implemented by software (a central processing unit (CPU)). These functions may also be implemented by multiple circuits or multiple pieces of software. The function of the storage unit 44 is implemented by a storage device such as a hard disk drive (HDD).

The discharge control unit 41 controls the discharge of liquid droplets by the MEMS chip 6 by controlling the application of the driving waveform to the MEMS chip 6 by the driving waveform generation source 7. The supply control unit 42 controls the supply of liquid to the MEMS chip 6 by the supplying unit 2.

The factor control unit 43 causes the supplying unit 2 to feed or suck liquid in response to the back electromotive force of the piezoelectric element 63 detected based on the current detected by the ammeter 3, thereby controlling the liquid volume E held in the chamber 61.

Further, the relationship between a deviation amount ΔT₀ from a set value of the resonance period T₀ of the membrane 62 and the liquid volume E is predetermined and stored in the storage unit 44. The factor control unit 43 detects the deviation amount ΔT₀ from the back electromotive force of the piezoelectric element 63 and acquires liquid volume information that is the control target value by referring to the storage unit 44. Then, the supplying unit 2 is caused to feed or suck the liquid, and control can be implemented so that the liquid volume E held in the chamber 61 becomes the control target value.

### Example of Operation of the Liquid Droplet Discharging Apparatus 100a

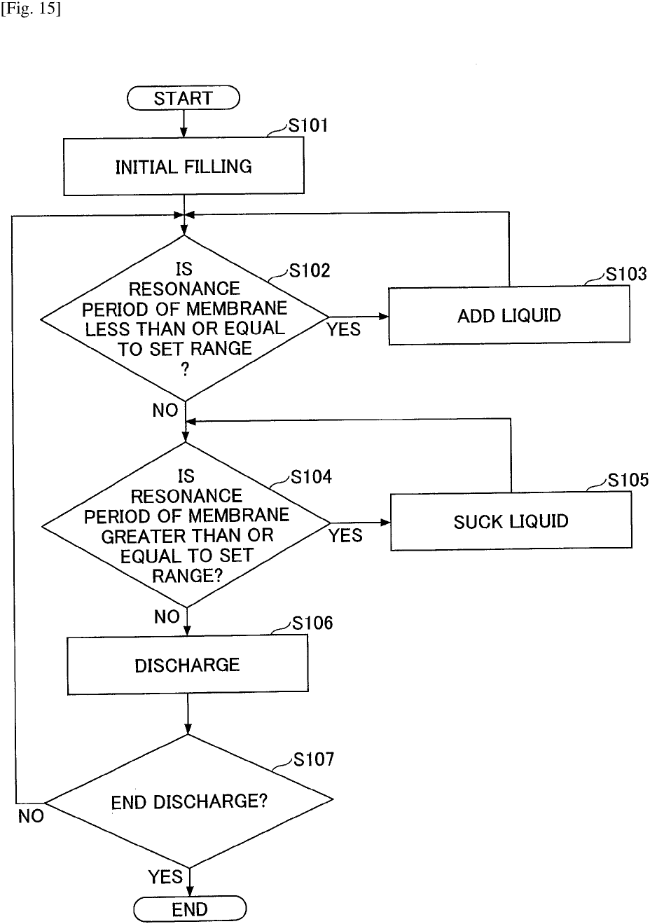

Next, an operation of the liquid droplet discharging apparatus 100a will be described with reference to FIG. 15. FIG. 15 is a flowchart illustrating an example of an operation of the liquid droplet discharging apparatus 100a.

First, in step S101, the supply control unit 42 drives the supplying unit 2 to initially fill the chamber 61 with the liquid 200.

Subsequently, in step S102, the discharge control unit 41 drives the driving waveform generation source 7 to apply a predetermined driving waveform for inspection to the piezoelectric element 63, and causes the MEMS chip 6 to discharge liquid. The ammeter 3 detects the back electromotive force of the piezoelectric element 63 at the time of the discharging, and the factor control unit 43 detects the resonance period T₀ of the membrane 62 based on the detection value of the ammeter 3.

Subsequently, the factor control unit 43 determines whether the resonance period T₀ of the membrane 62 is less than or equal to a set range determined in advance. This set range is a predetermined range on the negative side and the positive side with respect to a set value of the resonance period T₀. “Less than or equal to a set range” means that the resonance period T₀ is less than or equal to (the lower limit of) the set range on the negative side with respect to the set value of the resonance period T₀, that is, the detected value is too small compared to the set resonance period T₀.“Greater than or equal to the set range” means that the resonance period T₀ is greater than or equal to (the upper limit of) the set range on the positive side with respect to the set value of the resonance period T₀, that is, the detected value is too large compared to the set resonance period T₀.

In step S102, when it is determined that the resonance period T₀ is less than or equal to the set range (YES in step S102), in step S103, the factor control unit 43 acquires the liquid volume information that is the control target value by referring to the storage unit 44 based on the deviation amount ΔT₀ from the set value of the resonance period T₀.Then, the supplying unit 2 is caused to feed the liquid, and the liquid is added so that the liquid volume E held in the chamber 61 becomes the control target value. This causes the liquid volume E to increase and the resonance period T₀ to change to the desired value. Subsequently, the operation returns to step S102, and the operation of step S102 is performed again.

On the other hand, in step S102, when it is determined that the resonance period T₀ is not less than or equal to the set range (NO in step S102), in step S104, the factor control unit 43 determines whether the resonance period T₀ of the membrane 62 is greater than or equal to the set range determined in advance.

In step S104, when it is determined that the resonance period T₀ is greater than or equal to the set range (YES in step S104), in step S105, the factor control unit 43 acquires the liquid volume information that is the control target value by referring to the storage unit 44 based on the deviation amount ΔT₀ from the set value of the resonance period T₀.Then, the supplying unit 2 is caused to suck the liquid, so that the liquid volume E held in the chamber 61 becomes the control target value. This causes the liquid volume E to be reduced and changes the resonance period T₀ to the desired value. Subsequently, the operation returns to step S104, and the operation of step S104 is performed again.

On the other hand, in step S104, when it is determined that the resonance period T₀ is not greater than or equal to the set range (NO in step S104), in step S106, the discharge control unit 41 drives the driving waveform generation source 7 to apply, to the piezoelectric element 63, a predetermined driving waveform for discharging, and causes the MEMS chip 6 to discharge the liquid droplet D.

Subsequently, in step S107, the control unit 4 determines whether to end the discharging by the liquid droplet discharging apparatus 100a. This determination is made based on the user’s operation or the like to the liquid droplet discharging apparatus 100a.

In step S107, when it is determined to end the discharging (YES in step S107), the operation of the liquid droplet discharging apparatus 100a ends, and when it is determined not to end the discharging (NO in step S107), the operation returns to step S102, and the operations of steps S102 and onward are performed again.

In this manner, the liquid droplet discharging apparatus 100a can discharge the liquid droplet D while controlling the liquid volume E. Here, in the example illustrated in FIG. 15, the operation of sucking the liquid 200 is performed, but when it is required to only add the liquid 200 that has decreased due to the discharging, the determination (step S104) of whether the resonance period T₀ is greater than or equal to the set range may be omitted.

### Functional Effects of the Liquid Droplet Discharging Apparatus 100a

Next, the functional effects of the liquid droplet discharging apparatus 100a will be described.

In the liquid droplet discharging apparatus according to the first embodiment, the resonance period of the membrane varies according to the variation of the liquid volume when the continuously discharged amount is high, such that the resonance period T₀ of the membrane 62 and the driving waveform will not match each other (become inconsistent), and the discharging cannot be stably performed. This inconsistency between the resonance period T₀ and the driving waveform is, for example, the inconsistency between the resonance period T₀ and the aforementioned “time difference in the driving waveform”.

As a method of detecting the resonance period of the membrane with a high degree of sensitivity, usage of a measurement instrument such as a laser Doppler oscillation meter may be considered; however, this configuration would require an optical system to be positioned facing the membrane to irradiate the membrane with laser light as probe light. Thus, with this configuration, it is not possible to actually perform measurements by irradiating the membrane with laser light in a state where the membrane is placed inside the well.

Further, a method for estimating the resonance period of the membrane by measuring the liquid level height may also be considered. However, in this configuration, the resonance period of the membrane is estimated rather than measuring the actual resonance period of the membrane. Therefore, it is difficult to measure the resonance period of the membrane with high accuracy. Further, when a bubble is present in a chamber wall, etc., in the liquid within the chamber 61, the resonance period of the membrane varies due to the compression caused by the bubble. Therefore, the resonance period of the membrane cannot be measured with sufficient accuracy by only measuring the liquid level.

In contrast, in the present embodiment, the back electromotive force, which is generated by the piezoelectric element 63 that oscillates the membrane 62 that discharges the liquid droplet D from the nozzle hole 621, is detected, and the liquid volume E in the chamber 61 that contributes to the oscillation characteristic of the membrane 62 is controlled based on the detection result. Accordingly, the resonance period T₀, which varies according to the liquid volume E, can be controlled to be a desired value, so that the oscillation of the membrane 62 can be accurately controlled. The resonance period T₀ of the membrane 62 is matched to the “time difference in the driving waveform”, so that discharging failures are reduced and the liquid droplets D can be discharged stably.

Further, although the back electromotive force can be detected by a bulk-like or sheet-like piezoelectric element, in this case, the detection sensitivity may be low. In order to increase the detection sensitivity, it is possible to design a membrane in which the oscillation displacement is increased; however, in this case, it would be required to use a membrane for discharging in which the oscillation displacement is higher than the range in which the discharge head can perform suitable discharging. Therefore, it may be difficult to achieve both the stabilizing of discharging and the securing of detection sensitivity.

In contrast, in the present embodiment, the membrane 62 is formed on the MEMS chip 6, and, therefore, the membrane 62 can be downsized, and thus the oscillation displacement for suitable discharging can be increased. For example, in a typical membrane, the oscillation displacement for suitable discharging is approximately 0.1 µm, whereas in the membrane 62 according to the present embodiment, discharging can be suitably performed with an oscillation displacement of several µm to several tens of µm.Accordingly, a large back electromotive force can be obtained with a large oscillation displacement, while performing stable discharging, and the back electromotive force can be detected with high sensitivity. As a result, it is possible to achieve both the stabilizing of the discharging and the securing of the detection sensitivity.

Other effects are the same as those described in the first embodiment.

### Third Embodiment

Next, a liquid droplet discharging apparatus according to the third embodiment will be described.

In the present embodiment, an adjustment member is provided at a position facing the nozzle hole formed in the film-like member, in such a manner that at least a portion of the adjustment member is in contact with the liquid in the liquid chamber. The oscillation of the film-like member is accurately controlled by controlling the distance between the nozzle hole and the adjustment member as a factor contributing to the oscillation characteristic of the film-like member, based on at least one of the current and the voltage generated by the exciter.

### Example of Configuration of a MEMS Chip 6a

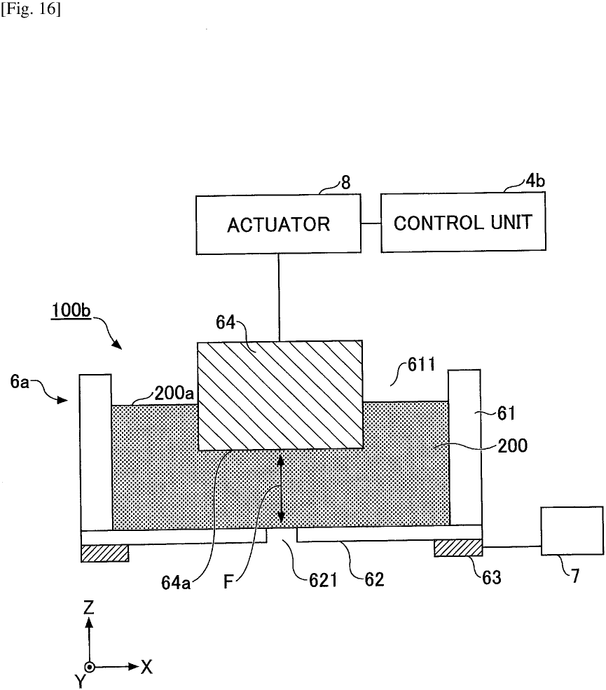

FIG. 16 is a diagram illustrating an example of the configuration of the MEMS chip 6a of a liquid droplet discharging apparatus 100b according to the present embodiment.

As illustrated in FIG. 16, the MEMS chip 6a includes an adjustment member 64 at a position facing the nozzle hole 621 formed in the membrane 62. The adjustment member 64 is provided such that at least an opposing surface 64a of the adjustment member 64 that faces the membrane 62 (the surface on the -Z direction side) is positioned in contact with the liquid 200 filled in the chamber 61.

By adjusting the position (height) of the adjustment member 64 in the Z direction within the range where the opposing surface 64a is in contact with the liquid 200, a distance F between the nozzle hole 621 and the opposing surface 64a of the adjustment member 64 changes. Thus, the volume of the portion of the adjustment member 64 that is immersed in the liquid 200 changes, and the height of a liquid level 200a of the liquid 200 changes according to this change in the volume, thereby changing the resonance period T₀ of the membrane 62. Therefore, by adjusting the height of the adjustment member 64 to control the distance F, it is possible to change the resonance period T₀ of the membrane 62 without changing the liquid volume E.

The sensitivity in changing the height of the liquid level 200a in accordance with the distance F varies depending on the size of the adjustment member 64. Therefore, the size of the adjustment member 64 is to be determined as appropriate depending on the required sensitivity. The material of the adjustment member 64 is not particularly limited and may be, for example, a metallic material, a ceramic material, a polymeric material, or the like.

Further, the position of the adjustment member 64 in the Z direction can be adjusted by having a control unit 4b drive an actuator 8 coupled to the adjustment member 64. As the actuator 8, an actuator driven by a piezoelectric element or an actuator driven by a motor, etc., is applicable.

### Example of Function Configuration of the Control Unit 4b

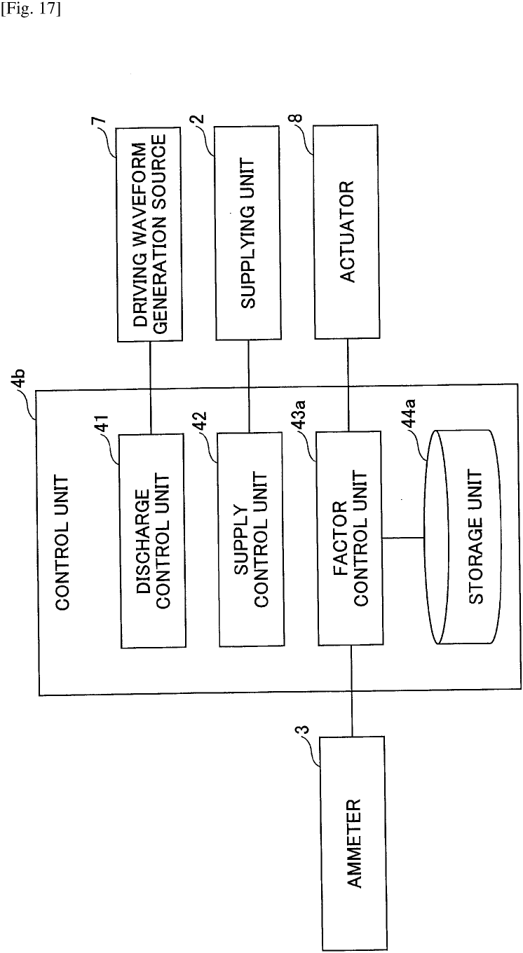

FIG. 17 is a block diagram illustrating an example of a functional configuration of the control unit 4b. As illustrated in FIG. 17, the control unit 4b includes a factor control unit 43a and a storage unit 44a. The factor control unit 43a drives the actuator 8 to control the distance F between the nozzle hole 621 and the adjustment member 64.

In the storage unit 44a, the relationship between the deviation amount ΔT₀ from the set value of the resonance period T₀ of the membrane 62, and the distance F, is predetermined and stored. The factor control unit 43a detects the deviation amount ΔT₀ from the back electromotive force of the piezoelectric element 63 and acquires distance information that is a control target value by referring to the storage unit 44a. The actuator 8 is then driven so that the distance F between the nozzle hole 621 and the adjustment member 64 can be controlled to be the control target value.

### Example of Operation of the Liquid Droplet Discharging Apparatus 100b

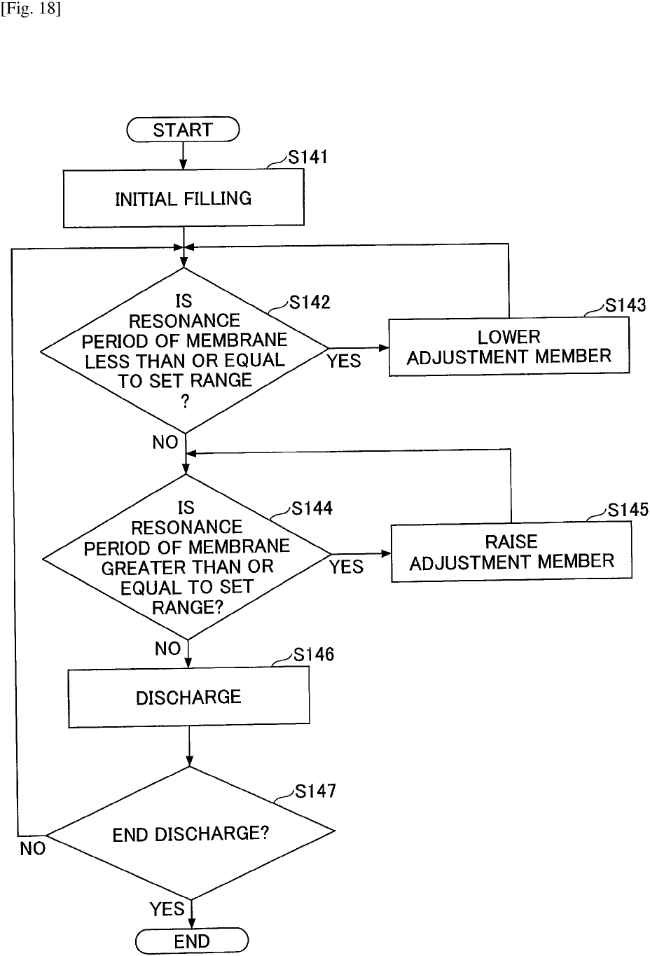

Next, an operation of the liquid droplet discharging apparatus 100b will be described with reference to FIG. 18. FIG. 18 is a flowchart illustrating an example of an operation of the liquid droplet discharging apparatus 100b. Note that the operations of steps S141 and S142 in FIG. 18 are the same as the operations of steps S101 and S102 in FIG. 15, and the operations of steps S146 and S147 in FIG. 18 are the same as the operations of steps S106 and S107 in FIG. 15. Therefore, the overlapping explanations thereof will be omitted here.

In step S142, when it is determined that the resonance period T₀ is less than or equal to the set range (YES in step S142), in step S143, the factor control unit 43a acquires the distance information that is the control target value by referring to the storage unit 44a based on the deviation amount ΔT₀ from the set value of the resonance period T₀. Then, the actuator 8 is driven so that the distance F becomes the control target value to lower the adjustment member 64. This causes the liquid level 200a of the liquid 200 to rise and the resonance period T₀ to be changed to a desired value. Subsequently, the operation returns to step S142, and the operation of step S142 is performed again.

On the other hand, in step S142, when it is determined that the resonance period T₀ is not less than or equal to the set range (NO in step S142), in step S144, the factor control unit 43a determines whether the resonance period T₀ of the membrane 62 is greater than or equal to the predetermined set range.

In step S144, when it is determined that the resonance period T₀ is greater than or equal to the set range (YES in step S144), in step S145, the factor control unit 43a acquires the distance information that is the control target value by referring to the storage unit 44a based on the deviation amount ΔT₀ from the set value of the resonance period T₀.The actuator 8 is then driven to raise the adjustment member 64. This lowers the liquid level 200a of the liquid 200 and changes the resonance period T₀ to a desired value. Subsequently, the operation returns to step S144, and the operation of step S144 is performed again.

In this manner, the liquid droplet discharging apparatus 100b can discharge the liquid droplet D while controlling the distance F.

As described above, in the present embodiment, there is provided the adjustment member 64 at a position facing the nozzle hole formed in the membrane 62, in such a manner that at least a portion of the adjustment member 64 is in contact with the liquid 200 in the chamber 61. By controlling the distance F between the nozzle hole 621 and the adjustment member 64 as a factor contributing to the oscillation characteristic of the membrane 62, based on at least one of the current and the voltage generated by the piezoelectric element 63, the oscillation of the membrane 62 can be accurately controlled with a simpler configuration without changing the liquid volume E.

The other effects are the same as those described in the first and second embodiments.

While embodiments of the present invention have been described with reference to examples, the present invention is not limited to the examples, and various modifications and substitutions may be made thereto without departing from the scope of the invention.

For example, a liquid droplet discharging apparatus includes a liquid chamber for holding a liquid, an atmospheric opening part for opening the liquid chamber to atmosphere, a film-like member in which a nozzle hole is formed for discharging the liquid held in the liquid chamber as a liquid droplet from the nozzle hole by oscillation, an exciter for oscillating the film-like member, a detector for detecting at least one of a current and a voltage generated by the exciter, and a controller for controlling a factor that contributes to the oscillation characteristic of the film-like member based on at least one of the current and the voltage.

For example, the voltage is a back electromotive force.

Further, the exciter includes a piezoelectric element.

Further, the film-like member and the exciter are integrally molded by a semiconductor process. The oscillation characteristic is an oscillation period. The oscillation period is a resonance period.

Further, the controller detects the oscillation period from the time intervals between the extreme values in the temporal variation of at least one of the current and the voltage, and controls the factor to match the oscillation period with a predetermined time difference in the driving waveform for oscillating the exciter.

Further, the liquid droplet discharging apparatus includes a supplier for feeding or sucking the liquid to change the liquid volume in the liquid chamber for holding the liquid, and the controller drives the supplier to control the liquid volume in the liquid chamber.

Further, the liquid droplet discharging apparatus includes an adjustment member provided at a position facing the nozzle hole, in such a manner that at least a portion of the adjustment member is in contact with the liquid. The controller changes the position of the adjustment member to control the distance between the nozzle hole and the adjustment member. The liquid is a cell suspension in which cells are suspended.

With the liquid droplet discharging apparatus described above, the oscillation of the film-like member can be accurately controlled by controlling the resonance period, which varies with the liquid volume, to be a desired value. As the resonance period of the film-like member is controlled to match the “time difference in the driving waveform”, it is possible to reduce discharging failures and to stably discharge liquid droplets.

### REFERENCE SIGNS LIST

1 discharge head
2 supplying unit
21 tube
22 supply needle
3 ammeter (an example of a detector)
4 control unit
41 discharge control unit
42 supply control unit
43 factor control unit
44 storage unit
5 well plate (an example of a container)
51 well (an example of a recessed portion)
6 MEMS chip (an example of an oscillator)
61 chamber (an example of a liquid chamber)
611 atmospheric opening part
612 liquid chamber member
612a lower electrode groove part (an example of a groove part)
612b upper electrode groove part (an example of a groove part)
613 elastic member
62 membrane (an example of a film-like member)
621 nozzle hole
63 piezoelectric element (an example of an exciter)
63a piezoelectric element (an example of a first piezoelectric element)
63b piezoelectric element (an example of a second piezoelectric element)
631 piezoelectric body
632 lower electrode
633 upper electrode
64 adjustment member
64a opposing surface
65 membrane support part (an example of a support member)
7 driving waveform generation source
8 actuator
9 head actuator (an example of a positioner)
71, 72 wiring
711 conductive adhesive
712 wiring coupling part
712a lower wiring coupling part
712b upper wiring coupling part
713a lower electrode coupling part
713b upper electrode coupling part
714a lower electrode wiring
714b upper electrode wiring
715 interlayer insulating film
716 insulating film
100 liquid droplet discharging apparatus
200 liquid (an example of a cell suspension)
250 sedimentable particles (an example of cells)
D liquid droplet
P1, P2, P3 waveform element
T₀ resonance period (an example of an oscillation characteristic, an example of an oscillation period)
T12, T23 time difference (an example of a predetermined time difference) E liquid volume (an example of a factor)
F distance (an example of a factor)
A membrane size
B liquid chamber member size

The present application is based on and claims priority of Japanese Priority Application No. 2020-040232 filed on Mar. 9, 2020, and Japanese Priority Application No. 2020-188503 filed on Nov. 12, 2020, the entire contents of which are hereby incorporated herein by reference.

1. A liquid droplet discharging method performed by a liquid droplet discharging apparatus configured to discharge a liquid droplet from a nozzle hole formed in a film-like member, the liquid droplet discharging method comprising:
positioning the nozzle hole inside a recessed portion provided in a container; and
discharging the liquid droplet from the nozzle hole positioned inside the recessed portion.

2. The liquid droplet discharging method according to claim 1, wherein
the positioning includes positioning an oscillator inside the recessed portion,
wherein the oscillator includes the film-like member, a support member configured to support the film-like member, and an exciter configured to oscillate the film-like member.

3. The liquid droplet discharging method according to claim 1 , wherein the liquid droplet includes a material constituting a living body or a biocompatible material.

4. The liquid droplet discharging method according to claim 1., wherein the positioning includes positioning the nozzle hole at a depth of 70% or more with respect to a depth of the recessed portion.

5. The liquid droplet discharging method according to claim 1., wherein
an outer shape of a planar portion of the recessed portion and an outer shape of a planar portion of the film-like member are both circular, and
a diameter of the film-like member is smaller than a diameter of the planar portion of the recessed portion.

6. A method for manufacturing a container including a tissue body, the method comprising:
positioning a nozzle hole, which is formed in a film-like member, inside a container provided with a recessed portion; and
discharging the tissue body from the nozzle hole positioned inside the recessed portion.

7. The method according to claim 6, wherein
the positioning includes positioning an oscillator inside the recessed portion,
wherein the oscillator includes the film-like member, a support member configured to support the film-like member, and an exciter configured to oscillate the film-like member.

8. A liquid droplet discharging apparatus comprising:
a discharge head configured to discharge a liquid droplet, wherein
the discharge head includes:
an oscillator including a film-like member including a nozzle hole, a support member configured to support the film-like member, and an exciter disposed on a part of the film-like member and on a part of the support member and configured to oscillate the film-like member; and
a liquid chamber member bonded to the oscillator and configured to hold a liquid, wherein
the oscillator is bonded to an end portion of the liquid chamber member that extends along a direction in which the liquid droplet is discharged.

9. The liquid droplet discharging apparatus according to claim 8, further comprising:
a positioner configured to position the oscillator inside a recessed portion provided in a container.

10. The liquid droplet discharging apparatus according to claim 8 , wherein the oscillator is integrally molded by a semiconductor process.

11. The liquid droplet discharging apparatus according to any claim 8, wherein the oscillator is bonded to the liquid chamber member via an elastic member.

12. The liquid droplet discharging apparatus according to claim 11, wherein
an outer shape of a planar portion of the film-like member is circular and the liquid chamber member is a cylindrical member, and
a diameter of the planar portion of the film-like member is smaller than an inner diameter of an end portion of the liquid chamber member on a side where the elastic member is disposed.

13. The liquid droplet discharging apparatus according to claim 8, wherein the exciter oscillates the film-like member according to a voltage applied through a wiring coupled to a plurality of electrodes via a conductive adhesive.

14. The liquid droplet discharging apparatus according to claim 13, wherein the wiring is accommodated within a housing part formed on an outer surface of the liquid chamber member.

15. The liquid droplet discharging apparatus according to any claim 8, wherein the liquid is a suspension including a cell.

16. The liquid droplet discharging apparatus according to claim 8, wherein the exciter includes a piezoelectric element.

17. The liquid droplet discharging apparatus according to any claim 8, further comprising:
a detector configured to detect at least one of a current and a voltage generated by the exciter; and
a controller configured to control a factor contributing to an oscillation characteristic of the film-like member based on at least one of the current and the voltage.

18. The liquid droplet discharging apparatus according to claim 17, wherein the voltage is a back electromotive force generated according to deformation of a piezoelectric element included in the exciter.

19. The liquid droplet discharging apparatus according to claim 18, wherein the piezoelectric element includes:
a first piezoelectric element configured to oscillate the film-like member; and
a second piezoelectric element configured to detect the back electromotive force.

20. The liquid droplet discharging apparatus according to claim 17, wherein the oscillation characteristic is an oscillation period.
